(19) United States
(12) Patent Application Publication
(10) Pub. No.: US 2003/0063879 A1
(43) Pub. Date: Apr. 3, 2003

(54) Optical transmission line and optical communication system

(75) Inventors: Masao Tsukitani, Yokohama-shi (JP); Toshiyuki Miyamoto, Yokohama-shi (JP)

Correspondence Address: McDERMOTT, WILL & EMERY, 600 13th Street, N.W., Washington, DC, 20005-3096, US

(73) Assignee: Sumitomo electric Industries, Ltd.

(21) Appl. No.: 10/224,488

(22) Filed: Aug. 21, 2002

(30) Foreign Application Priority Data
Aug. 27, 2001 (JP) 256778/2001

(51) Int. Cl. G02B 6/16; G02B 6/22; G02B 6/18; G02B 6/28

(52) U.S. Cl. 385/123; 385/127; 385/124; 385/24

(57) ABSTRACT

An optical transmission line and an optical communication system for high-quality transmission of signal light using distributed Raman amplification are disclosed. In an optical communication system 1, an optical transmission line 10 including a first optical fiber 11 and a second optical fiber 12, which are connected to each other by means of fusion, is disposed between an optical repeater 30 and an optical repeater 40. The effective core area of the optical fiber 11 is smaller than the effective core area of the optical fiber 12. The absolute value of the chromatic dispersion of the optical fiber 12 is smaller than that of the optical fiber 11. When the lengths of the optical fibers 11 and 12 are represented by L₁ and L₂, respectively, the ratio L₂/(L₁+L₂) is not less than 0.5.

### BACKGROUND OF THE INVENTION

1. Field of the Invention

The present invention relates to an optical transmission line suitable for transmitting signal light while Raman amplifying the signal light, and to an optical communication system including such an optical transmission line.

2. Description of the Background Art

The distributed Raman amplification is a technique of supplying Raman amplification pumping light to an optical transmission line disposed between stations and thereby Raman amplifying the signal light while the signal light propagates through the optical transmission line. In an optical transmission line in which signal light is amplified by distributed Raman-amplification, the intrinsic transmission loss is canceled by the Raman amplification gain, and the effective transmission loss is reduced accordingly. This makes it possible to achieve long-haul transmission.

To improve the optical transmission quality, it is important to reduce the absolute value of the overall chromatic dispersion of the optical transmission line. To this end, there is a case in which an optical transmission line is formed by combining a first optical fiber and a second optical fiber together, wherein the first optical fiber has a positive chromatic dispersion and a large effective core area while the second optical fiber has a negative chromatic dispersion and a small effective core area. In this type of optical transmission line, to suppress signal degradation due to nonlinear optical phenomena, the first optical fiber is generally disposed on the upstream side of the optical transmission line, and the second optical fiber is disposed on the downstream side.

In this optical transmission line, the power of signal light propagating through the second optical fiber is small. The second optical fiber has a small effective core area and a high Raman amplification efficiency. Thus, it has been proposed to amplify the signal light by supplying Raman amplification pumping light to the second optical fiber.

### SUMMARY OF THE INVENTION

It is an object of the present invention to provide an optical transmission line and an optical communication system, which allow high-quality transmission of signal light using distributed Raman amplification.

According to a first aspect of the present invention, to achieve the above object, there is provided an optical transmission line comprising a first optical fiber having a length of L₁, a first effective core area, and a first positive chromatic dispersion, and a second optical fiber having a length of L₂, a second effective core area, and a second negative chromatic dispersion, wherein the first and second optical fibers are connected together. In this optical transmission line, the second optical fiber includes a core, a cladding, and a depressed region which is disposed between the core and the cladding and has a refractive index smaller than refractive indexes of the core and cladding, the second effective core area is smaller than the first effective core area, the second chromatic dispersion is smaller in absolute value than the first chromatic dispersion, and the ratio (L₂/(L₁+L₂)) is not less than 0.5. Herein, the values of the effective core areas and the chromatic dispersions are those at a wavelength of 1550 nm.

In one embodiment of the optical transmission line according to the first aspect of the present invention, the ratio (L₂/(L₁+L₂)) may be not less than 0.55 and not more than 0.60. The second optical fiber may be disposed on the downstream side of the first optical fiber. The first effective core area may be not less than 100 μm², and the second effective core area may be not less than 20 μm². The relative refractive index difference of the core of the second optical fiber to the cladding may be not less than 0.9% and not more than 1.0%.

According to a second aspect of the present invention, there is also provided an optical transmission line comprising a first optical fiber having a length of L₁, a first effective core area, and a first chromatic dispersion being positive, a second optical fiber having a length of L₂, a second effective core area, and a second chromatic dispersion being negative, and a third optical fiber having a length of L₃, a third effective core area, and a third chromatic dispersion being positive, wherein the first, second, and third optical fibers are connected in this sequence between the signal light incidence position and the signal light exit position. In this optical transmission line, the second optical fiber includes a core, a cladding, and a depressed region which is disposed between the core and the cladding and has a refractive index smaller than refractive indexes of the core and the cladding, the second effective core area is smaller than the first effective core area and the third effective core area, the second chromatic dispersion is not less than −73 ps/nm/km and not more than −46 ps/nm/km, and the ratio L₂/(L₁+L₂+L₃) is not less than 0.2 and not more than 0.4. Herein, the values of the effective core areas and the chromatic dispersions are those at a wavelength of 1550 nm.

In the optical transmission line according to the second aspect of the present invention, the first effective core area may be not less than 100 μm², the second effective core area may be not less than 15 μm², and the third effective core area may be not less than 100 μm². The relative refractive index difference of the core of the second optical fiber to the cladding may not less than 1.4% and not more than 1.8%. The ratio R=((L₁+0.5L₂)/(L₁+L₂+L₃)) may be not less than 0.4 and not more than 0.5, and Raman amplification pumping light used for Raman amplification of signal light may be supplied from the side of the light emerging-out position. Alternatively, the ratio R may be not less than 0.5 and not more than 0.7, and Raman amplification pumping light used for Raman amplification of signal light may be supplied both from the side of the light incidence position and from the side of the light emerging-out position.

The present invention is also directed to an optical communication system comprising a first or second optical transmission line and a Raman amplification pumping light source for supplying Raman amplification pumping light to the optical transmission line such that the optical communication system is capable of transmitting signal light through the optical transmission line while Raman amplifying the signal light propagating through the optical transmission line.

The present invention is further explained below by referring to the accompanying drawings. The drawings are provided solely for the purpose of illustration and are not intended to limit the scope of the invention.

### BRIEF DESCRIPTION OF THE DRAWINGS

FIG. 1 is a schematic diagram illustrating an optical communication system 1 and an optical transmission line 10 according to a first embodiment of the present invention.

FIG. 2 is a diagram illustrating a refractive index profile of an optical fiber 12.

FIG. 3 is a graph showing the relationship between the relative refractive index difference Δn₁ and the performance of the optical transmission line 10.

FIG. 4 is an enlarged partial diagram of FIG. 3.

FIG. 5 is a graph showing the relationship between the relative refractive index difference Δn₁ and the power of Raman amplification pumping light adjusted so that the effective transmission loss of the optical transmission line 10 becomes equal to 0.

FIG. 6 is a schematic diagram illustrating an optical communication system 2 and an optical transmission line 20 according to a second embodiment of the present invention.

FIG. 7 is a graph showing the relationship between the relative refractive index difference Δn₁ and the performance of the optical transmission line 20.

FIG. 8 is an enlarged partial diagram of FIG. 7.

FIG. 9 is a graph showing the relationship between the relative refractive index difference Δn₁ and the power of Raman amplification pumping light adjusted so that the effective transmission loss of the optical transmission line 20 becomes equal to 0.

FIG. 10 is a graph showing the relationship between the relative refractive index difference Δn₁ and the performance of the optical transmission line in the first and second embodiments.

FIG. 11 is a graph showing the relationship between the relative refractive index difference Δn₁ and the power of Raman amplification pumping light in the first and second embodiments.

FIG. 12 is a graph showing the relationship between the location of the optical fiber 12 and the performance of the optical transmission line 20, for a case in which forward pumping is employed in the second embodiment.

FIG. 13 is a graph showing the relationship between the location of the optical fiber 12 and the performance of the optical transmission line 20, for a case in which backward pumping is employed in the second embodiment.

FIG. 14 is a graph showing the relationship between the location of the optical fiber 12 and the performance of the optical transmission line 20, for a case in which bi-directional pumping is employed in the second embodiment.

### DETAILED DESCRIPTION OF THE INVENTION

Embodiments of the present invention are explained below by referring to the accompanying drawings. In the drawings, the same number refers to the same part to avoid duplicate explanation. The ratios of the dimensions in the drawings do not necessarily coincide with the explanation.

First Embodiment

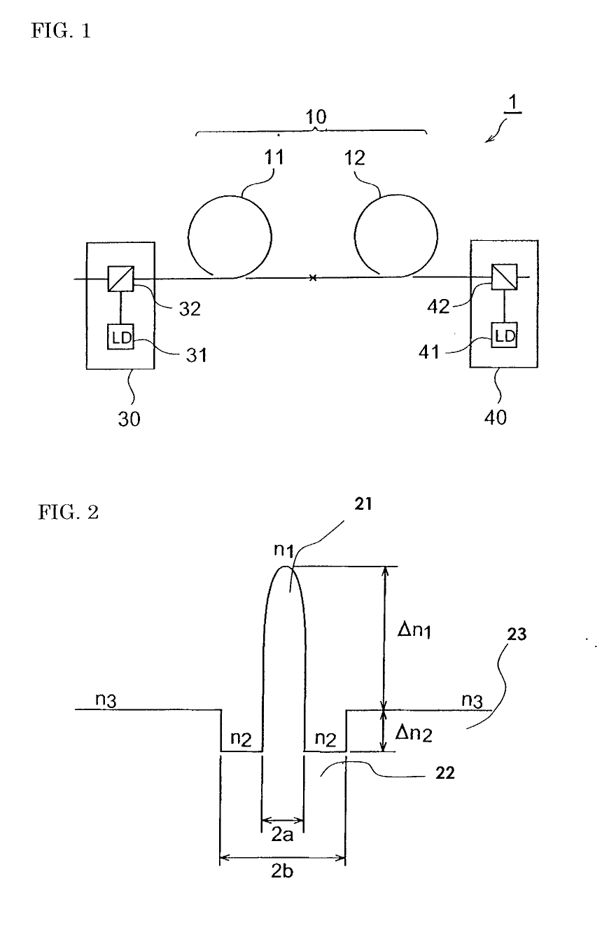

First, an optical communication system and an optical transmission line according to a first embodiment of the present invention are described. FIG. 1 is a schematic diagram illustrating the optical communication system 1 and the optical transmission line 10 according to the first embodiment of the present invention. In this optical communication system 1, the optical transmission line 10 is disposed between an optical repeater (or optical transmitter) 30 and an optical repeater (or optical receiver) 40. The optical transmission line 10 includes a first optical fiber 11 and a second optical fiber 12 which are connected together by means of fusion splicing.

The optical fiber 11 has a relatively large effective core area A_{eff1} and a positive chromatic dispersion D₁ at a wavelength of 1550 nm. The optical fiber 11 includes a core made of pure silica glass including the center of an optical axis, and a cladding doped with fluorine and formed around the core. Because the core is made of pure silica glass, the optical fiber 11 has a low transmission loss.

On the other hand, the optical fiber 12 has a relatively small effective core area A_{eff2} and a negative chromatic dispersion D₂ at a wavelength of 1550 nm so that the chromatic dispersion of the optical fiber 11 is compensated by the optical fiber 12. The optical fiber 12 has a refractive index profile such as that shown in FIG. 2. That is, the optical fiber 12 includes a core 21 having a refractive index n₁ and including an optical axis, a depressed region 22 having a refractive index n₂, and a cladding 23 having a refractive index n₃, wherein n₁>n₃>n₂. The optical fiber 12 is formed using silica glass as a base material. The core 21 may be doped with germanium oxide (GeO₂) and the depressed region 22 may be doped with fluorine. The optical fiber 12 is made to exhibit negative chromatic dispersion D₂ by properly setting the ratio Ra (=a/b) between the outer diameter 2a of the core 21 and the outer diameter 2b of the depressed region 22, the relative refractive index difference Δn₁ of the core 21 relative to the cladding 23, and the relative refractive index difference Δn₂ of the depressed region 22 to the cladding 23.

It is also preferable that the optical fiber 12 further includes a ring portion with a refractive index n₄ disposed between the depressed region 22 and the cladding 23, and the refractive indexes are set such that n₁>n₄>n₃>n₂. Furthermore, the optical fiber 12 may include two or more depressed regions 22 with a low refractive index, although the purposes of the present invention can be achieved if the optical fiber 12 includes at least one depressed region 22.

At the optical signal wavelength, the effective core areas A_{eff1} and A_{eff2}, and the chromatic dispersions D₁ and D₂ satisfy the following relationships:

A_{eff2}<A_{eff1} (1a)

D₂<0<|D₂|<D₁ (1b)

The length L₁ of the optical fiber 11 and the length L₂ of the optical fiber 12 satisfy the following relationship:

$$\frac{{L}_{2}}{{L}_{1} + {L}_{2}} \geq 0.5 \qquad ( 2 )$$

and, more preferably, satisfy the following relationship:

$$0.55 \leq \frac{{L}_{2}}{{L}_{1} + {L}_{2}} \leq 0.60 \qquad ( 3 )$$

To reduce the nonlinearity, it is preferable that the effective core area A_{eff1} be not less than 100 μm² at the signal light wavelength, the effective core area A_{eff2} be not less than 20 μm², and the relative refractive index difference Δn₁ be not less than 0.9% and not more than 1.0%.

The optical repeater 30 includes an pumping light source 31 and an optical coupler 32. The pumping light source 31 emits pumping light used for Raman amplification, and the optical coupler 32 supplies the pumping light to the optical fiber 11. More specifically, the optical repeater 30 supplies the Raman amplification pumping light to the optical transmission line 10 frontward. The Raman amplification pumping light has a wavelength shorter than the signal light wavelength by about 100 nm.

Similarly, the optical repeater 40 includes an pumping light source 41 and an optical coupler 42. The optical repeater 40 supplies the Raman amplification pumping light to the optical transmission line 10 backward.

In this optical communication system 1, the Raman amplification pumping light emitted from the pumping light source 31 is sequentially supplied to the optical fiber 11 and then to optical fiber 12. On the other hand, the Raman amplification pumping light emitted from the pumping light source 41 is sequentially supplied first to the optical fiber 12 and then to optical fiber 11. Signal light propagates first through the optical fiber 11 and then through the optical fiber 12 and reaches the optical repeater 40, wherein the signal light is amplified by means of Raman amplification during the propagation through the optical fibers In the optical communication system 1 and the optical transmission line 10 according to the present embodiment, the effective core areas A_{eff1} and A_{eff2}, the chromatic dispersions D₁ and D₂, and the lengths L₁ and L₂ are set such that the relationships described above are satisfied, thereby achieving high performance in terms of both the optical signal-to-noise ratio and nonlinearity and thus achieving high-quality transmission of signal light using distributed Raman amplification.

Specific examples of the optical communication system 1 and the optical transmission line 10 according to the first embodiment are described below. Table shows various parameters of the optical fibers which were actually used to form the optical transmission line 10.

TABLE I

| Fiber | 11 | 12a | 12b | 12c | 12d | 12e | 12f | 12g | 12h | Reference |
|---|---|---|---|---|---|---|---|---|---|---|
| Relative Index difference | | 0.8 | 0.9 | 1.0 | 1.2 | 1.4 | 1.6 | 1.8 | 2.0 | |
| Loss at 1450 nm dB/km | 0.2 | 0.25 | 0.25 | 0.25 | 0.26 | 0.28 | 0.32 | 0.39 | 0.50 | 0.25 |
| Loss at 1550 nm dB/km | 0.17 | 0.21 | 0.21 | 0.21 | 0.22 | 0.24 | 0.27 | 0.31 | 0.37 | 0.20 |
| Chromatic dispersion | 20.4 | −7.8 | −14.1 | −17.1 | −30.3 | −46.0 | −58.2 | −72.4 | −86.0 | 8.0 |
| ps/nm/km | | | | | | | | | | |
| Dispersion slope | 0.059 | −0.021 | −0.040 | −0.048 | −0.087 | −0.133 | −0.164 | −0.210 | −0.253 | 0.060 |
| ps/nm²/km | | | | | | | | | | |
| Effective core area μm² | 110 | 31.0 | 28.1 | 26.4 | 22.9 | 20.5 | 18.8 | 17.5 | 16.3 | 65.3 |
| Gain coefficiency | 0.28 | 1.08 | 1.24 | 1.38 | 1.7 | 2.05 | 2.41 | 2.80 | 3.26 | 0.49 |
| Non-linear index | 2.8 | 3.4 | 3.4 | 3.5 | 3.7 | 3.8 | 3.9 | 4.1 | 4.2 | 2.9 |
| L2/(L1 + L2) | | 72.3 | 59.1 | 54.4 | 40.2 | 30.7 | 26.0 | 22.0 | 19.2 | |

As for the optical fiber 11, a single-mode optical fiber including a core made of pure silica glass and having a zero-dispersion wavelength near 1.3 μm was used.

Optical fibers 12a to 12h actually employed as the optical fiber 12 had a relative refractive index difference Δn₁ in the range from 0.8% to 2.0% and a transmission loss in the range from 0.25 to 0.50 dB/km at a wavelength of 1450 nm and from 0.21 to 0.37 dB/km at a wavelength of 1550 nm. Furthermore, the chromatic dispersion thereof was in the range from −7.8 to −86.0 ps/nm/km, the dispersion slope was in the range from −0.021 to −0.253 ps/nm²/km, the effective core area was in the range from 31.0 to 16.3 μm², the Raman amplification gain factor (g_{R}/A_{eff}) was in the range from 1.08 to 3.26/W/km, and the nonlinear refractive index n₂ was in the range from 3.4×10⁻²⁰ to 4.2×10⁻²⁰ m²/W. The values described herein are those measured at a wavelength of 1550 nm except for the transmission loss. The parameters of the optical fibers 12a to 12h were set so that the bending loss for a bending diameter of 20 mmφ at a wavelength of 1550 nm became 10 dB/m.

In the present example, the optical transmission line 10 was formed by connecting one of optical fibers 12a to 12h to the optical fiber 11. The length of each optical fiber was adjusted so that the overall chromatic dispersion of the whole optical transmission line 10 became 0 at a wavelength of 1550 nm. The total length, L₁+L₂, of the optical transmission line 10, was set to 100 km. The signal light wavelength was set to 1550 nm, and Raman amplification pumping light with a wavelength of 1450 nm was employed. Optical signal power of 0 dBm was input to the optical transmission line 10. The power of the Raman amplification pumping light was adjusted so that the effective transmission loss of the optical transmission line 10 became equal to 0, that is, so that the power of the signal light output from the optical transmission line 10 became equal to the power of the signal light input to the optical transmission line 10.

The performance of the optical transmission line 10 in the case of using the distributed Raman amplification was evaluated in comparison with the performance achieved by a reference system which was formed by connecting an optical transmission line including only a reference optical fiber (i.e., a dispersion shifted fiber having a zero-dispersion wavelength shifted from 1.3 μm to a longer wavelength) to an erbium-doped fiber amplifier (EDFA) having a signal-to-noise ratio of 5 dB. Herein, the performance (PFM) of the optical transmission line 10 is defined as follows:

PFM=improvement of OSNR+improvement of nonlinearity (4a)

In this definition,

Improvement of OSNR=10·log OSNR_{Raman}/OSNR_{basis} (4b)

Improvement of nonlinearity=10·log Δφ_{Raman}/Δφ_{basis} (4c)

where OSNR_{Raman} and Δφ_{Raman} are the optical signal-to-noise ratio and the phase shift, respectively, for the optical transmission line 10, and OSNR_{basis} and Δφ_{basis} are those for the reference system.

The phase shift Δφ_{Raman} is the overall phase shift of the optical transmission line 10 caused by self phase modulation, for fixed power of light incident on the optical transmission line 10. The optical signal-to-noise ratio OSNR_{basis} was calculated on the assumption that the degradation of the optical signal-to-noise ratio of the EDFA was 5 dB. In the phase shift Δφ_{basis}, the phase shift of the EDFA was ignored, because the length of the EDFA is much shorter than the length of the optical transmission line.

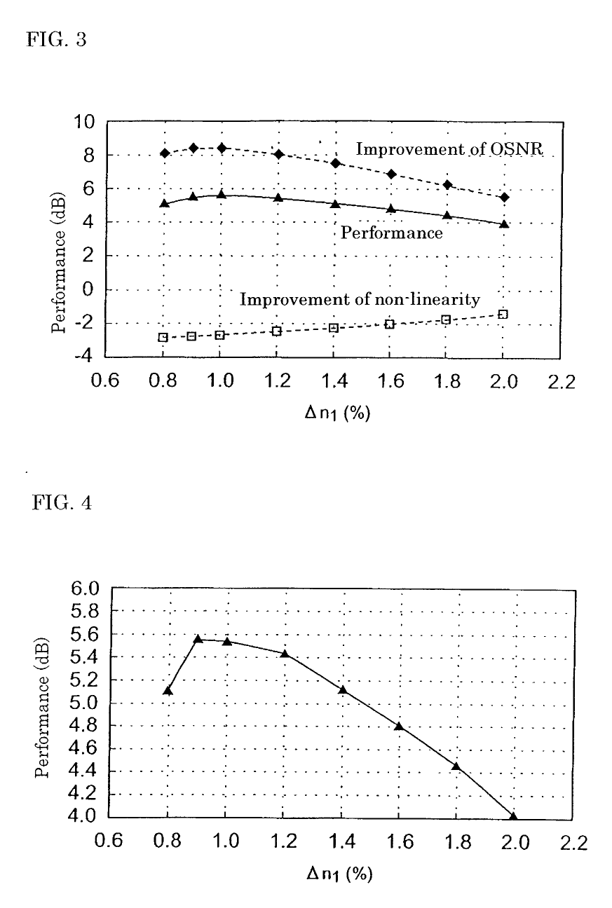

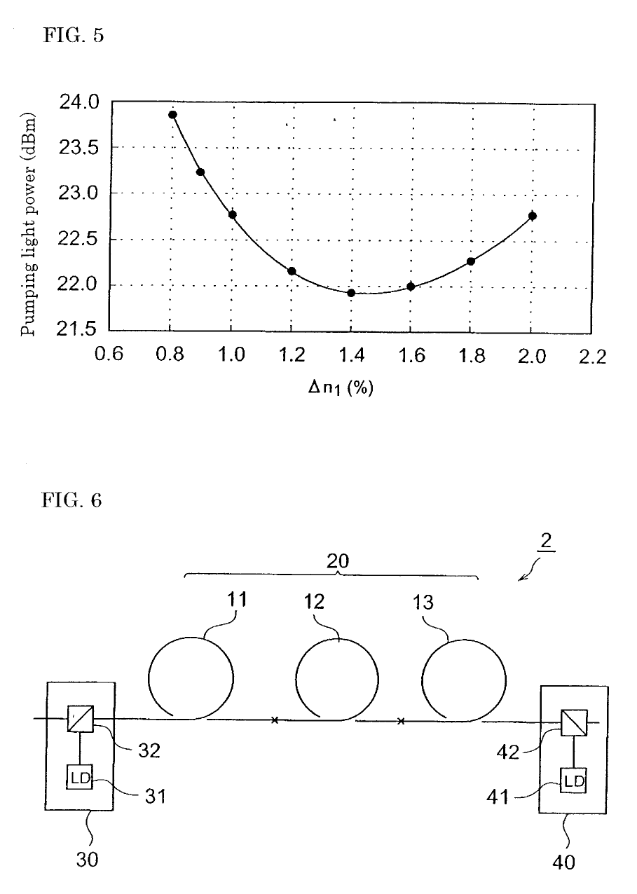

FIGS. 3 and 4 are graphs showing the relationship between the relative refractive index difference Δn₁ of the optical fiber 12 and the PFM of the optical transmission line 10. In FIG. 3, the improvement of OSNR and the improvement of nonlinearity are also shown in addition to the PFM. FIG. 4 is an enlarged partial graph of FIG. 3 showing the PFM. FIG. 5 is a graph showing the relationship between the relative refractive index difference Δn₁ and the power of Raman amplification pumping light adjusted so that the effective transmission loss of the optical transmission line 10 became equal to 0.

As can be seen from FIGS. 3 and 4, a greater reduction in the nonlinearity of the optical transmission line 10 was obtained with increasing relative refractive index difference Δn₁. That is, less significant degradation due to nonlinear optical phenomena occurred in the area of large Δn₁. This is consistent with the fact that the larger the relative refractive index difference Δn₁ of the optical fibers 12a through 12h, the shorter is the required length L₂. The improvement of the OSNR was greater than the improvement of the nonlinearity for all values of the relative refractive index difference Δn₁, and a greatest improvement of the OSNR was obtained when the relative refractive index difference Δn₁ was about 1.0%. Highest performance was obtained when the relative refractive index difference Δn₁ was in the range of 0.9% to 1.0%. In other words, in the optical communication system 1 or the optical transmission line 10, optimum distributed Raman amplification can be achieved by setting the relative refractive index difference Δn₁ of the optical fiber 12 within the range of 0.9% to 1.0%. High performance was obtained when the ratio (L₂/(L₁+L₂)) of the length of the optical fiber 12 to the total length of the optical transmission line 10 was not less than 0.5, and the highest performance was obtained when the ratio was not less than 0.55 and not more than 0.60.

Second Embodiment

An optical communication system and an optical transmission line according to a second embodiment of the present invention are described below. FIG. 6 is a schematic diagram illustrating the optical communication system 2 and the optical transmission line 20 according to the second embodiment of the present invention. In this optical communication system 2, an optical transmission line 20 is disposed between an optical repeater 30 and an optical repeater 40. The optical transmission line 20 includes a first optical fiber 11, a second optical fiber 12, and a third optical fiber 13, which are connected in this sequence means of fusion splicing.

The optical fibers 11 and 12 and the optical repeaters 30 and 40 are similar to those employed in the first embodiment. However, the optical transmission line 20 is different from the optical transmission line 10 in that it further includes the optical fiber 13 in addition to the optical fiber 11 and the optical fiber 12.

The optical fiber 13 is similar to the optical fiber 11, and has a relatively large effective core area A_{eff3} and a positive chromatic dispersion D₃ at signal light wavelength. The optical fiber 13 includes a core made of pure silica glass including an optical axis, and a cladding doped with fluorine and formed around the core. Because the core is made of pure silica glass, the optical fiber 13 has a low transmission loss.

At the optical signal wavelength, the effective core areas A_{eff1}, A_{eff2}, and A_{eff3} and the chromatic dispersion D₂ satisfy the following relationships:

A_{eff2}<A_{eff1} (5a)

A_{eff2}<A_{eff3} (5b)

−73 ps/nm/km≦D₂≦−46 ps/nm/km (5c)

The length L₁ of the optical fiber 11, the length L₂ of the optical fiber 12, and the length L₃ of the optical fiber 13 satisfy the following relationship:

$$0.2 \leq \frac{{L}_{2}}{{L}_{1} + {L}_{2} + {L}_{3}} \leq 0.4 \qquad ( 6 )$$

To reduce the nonlinearity, it is preferable that the effective core area A_{eff1} be not less than 100 μm² at the signal light wavelength, the effective core area A_{eff2} be not less than 15 μm², the effective core area A_{eff3} be not more than 100 μm², and the relative refractive index difference Δn₁ be not less than 1.4% and not more than 1.8%.

Furthermore, it is preferable that the ratio R=(L₁+0.5L₂)/(L₁+L₂+L₃) be not less than 0.4 and not more than 0.5, and Raman amplification pumping light be supplied to the optical fiber 13 from the optical repeater 40. Alternatively, the ratio R may be in the range not less than 0.5 and not more than 0.7, and Raman amplification pumping light may be supplied to the optical fiber 13 from the optical repeater 40 and also to the optical fiber 11 from the optical repeater 30.

In this optical communication system 2, the Raman amplification pumping light emitted from the pumping light source 31 is supplied via a optical coupler 32 to the optical fiber 11, the optical fiber 12, and the optical fiber 13 in this sequence. On the other hand, the Raman amplification pumping light emitted from the pumping light source 41 is supplied via a optical coupler 42 to the optical fiber 13, the optical fiber 12, and the optical fiber 11 from in this sequence. The signal light output from the optical repeater 30 propagates through the optical fiber 11, the optical fiber 12, and the optical fiber 13 in this sequence and is amplified by means of Raman amplification during the propagation to reach the optical repeater 40.

In the optical communication system 2 and the optical transmission line 20 according to the present embodiment, distributed Raman amplification and high-quality transmission of signal light are made possible by setting the effective core areas A_{eff1}, A_{eff2}, and A_{eff3}, the chromatic dispersions D₁, D₂, and D₃, and the lengths L₁, L₂, and L₃ so as to satisfy the relationships described above.

Specific examples of the optical communication system 2 and the optical transmission line 20 according to the second embodiment are described below. In the examples, an optical fiber 11, optical fibers 12a to 12h, and a reference optical fiber, having characteristics or parameters similar to those shown in Table were used. As for the optical fiber 13, an optical fiber similar to the optical fiber 11 whose characteristics or parameters are shown in Table was used, and the length of the optical fiber 13 was set to be equal to the length of the optical fiber 11.

In the present examples, the optical fiber 11, one of the optical fibers 12a through 12h, and the optical fiber 13 were connected together in this sequence so as to form the optical transmission line 20. The length of each optical fiber was adjusted so that the overall chromatic dispersion of the whole optical transmission line 20 became 0 at a wavelength of 1550 nm. The total length, L₁+L₂+L₃, of the optical transmission line 20 was set to 100 km. A signal light wavelength was set to 1550 nm, and Raman amplification pumping light with a wavelength of 1450 nm was employed. Optical signal power of 0 dBm was input to the optical transmission line 20. The power of the Raman amplification pumping light was adjusted so that the effective transmission loss of the optical transmission line 20 became equal to 0. The performance of the optical transmission line 20 using distributed Raman amplification was evaluated in a similar manner as in the first embodiment in accordance with equations (4a) to (4c).

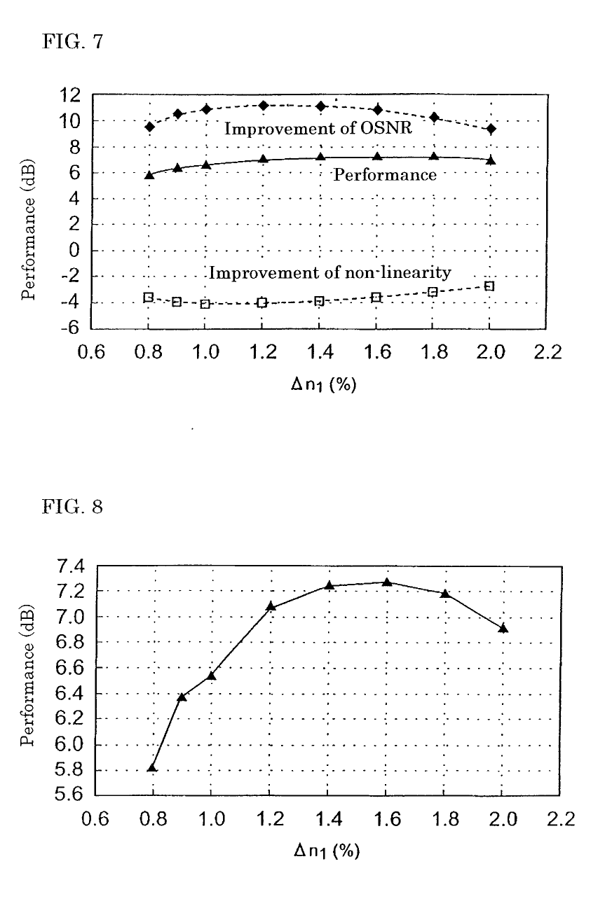

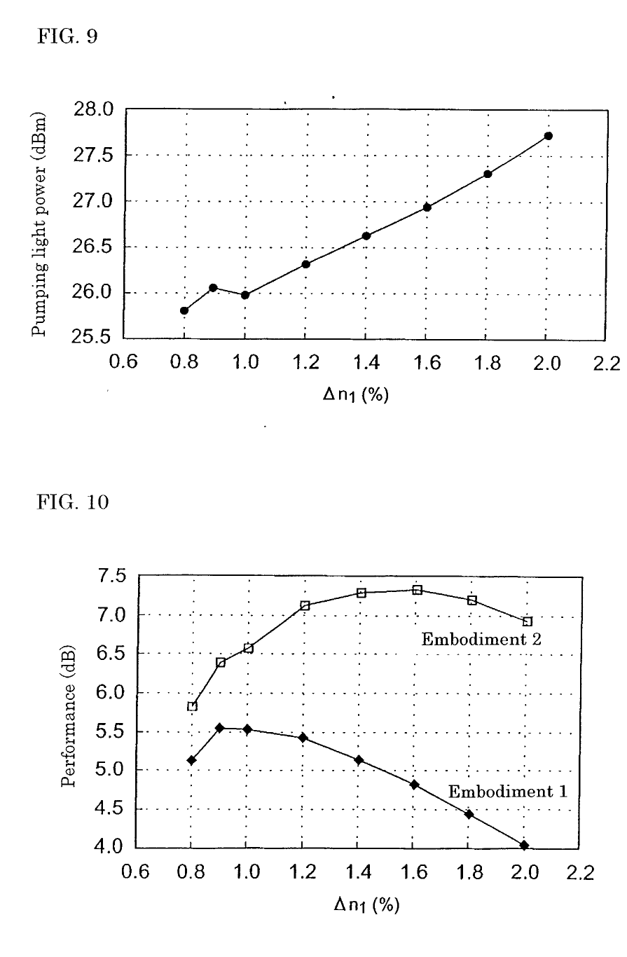

FIGS. 7 and 8 are graphs showing the relationship between the relative refractive index difference Δn₁ of the optical fiber 12 and the PFM of the optical transmission line 20. In FIG. 7, the improvement of OSNR and the improvement of nonlinearity are also shown in addition to the PFM. FIG. 8 is an enlarged partial graph of FIG. 7 showing the PFM. FIG. 9 is a graph showing the relationship between the relative refractive index difference Δn₁ of the optical fiber 12 and the power of Raman amplification pumping light adjusted so that the effective transmission loss of the optical transmission line 20 became equal to 0.

As can be seen from FIGS. 7 and 8, a reduction in the nonlinearity of the optical transmission line 20 became small when the relative refractive index difference Δn₁ was about 1.2%. That is, significant degradation due to nonlinear optical phenomena occurred. The improvement of OSNR was greater than the improvement of nonlinearity for all values of the relative refractive index difference Δn₁, and a greatest improvement of OSNR was obtained when the relative refractive index difference Δn₁ was about 1.0%. Highest performance was achieved when the relative refractive index difference Δn₁ was 1.4% to 1.8%. That is, in the optical communication system 2 or the optical transmission line 20, optimum distributed Raman amplification can be achieved by setting the relative refractive index difference Δn₁ of the optical fiber 12 within the range of 1.4% to 1.8%. The highest performance was obtained when the ratio of the length of the optical fiber 12 to the total length of the optical transmission line 20 (L₂/(L₁+L₂+L₃)) was not less than 0.2 and not more than 0.4 and in that case the chromatic dispersion D₂ of the optical fiber 12 was not less than −73 ps/nm/km and not more than −46 ps/nm/km.

FIG. 10 is a graph showing the relationship between the relative refractive index difference Δn₁ of the optical fiber 12 and the PFM of the optical transmission line, obtained in the first and second embodiments. As can be seen from FIG. 10, the PFM obtained in the second embodiment was higher than that achieved in the first embodiment, regardless of which of the optical fibers 12a to 12h was employed.

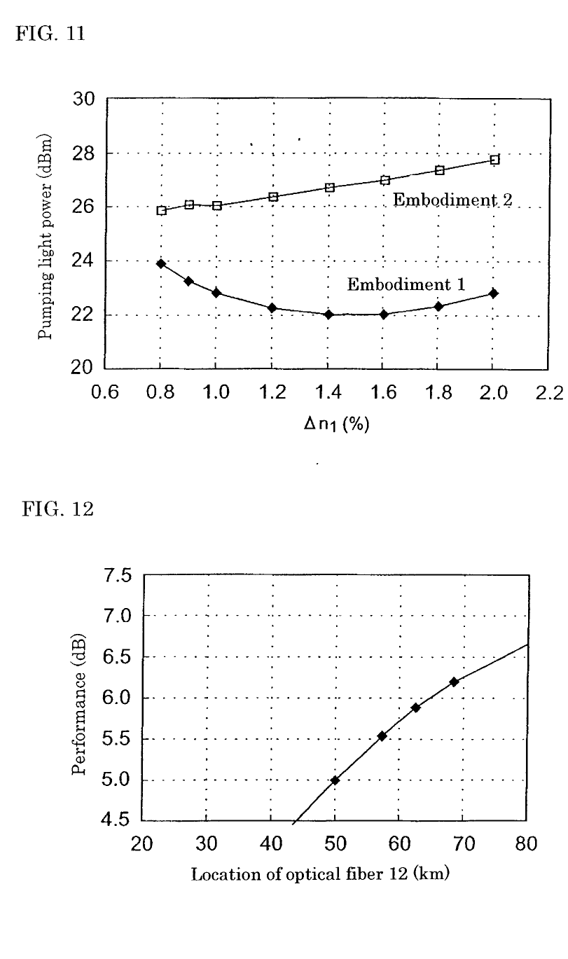

FIG. 11 is a graph showing the relationship between the relative refractive index difference Δn₁ of the optical fiber 12 and the power of Raman amplification pumping light adjusted so that the effective transmission loss became 0 in the first and second embodiments. As can be seen from FIG. 11, the required power of Raman amplification pumping light was greater in the second embodiment than in the first embodiment, regardless as to which of the optical fibers 12a to 12h was employed.

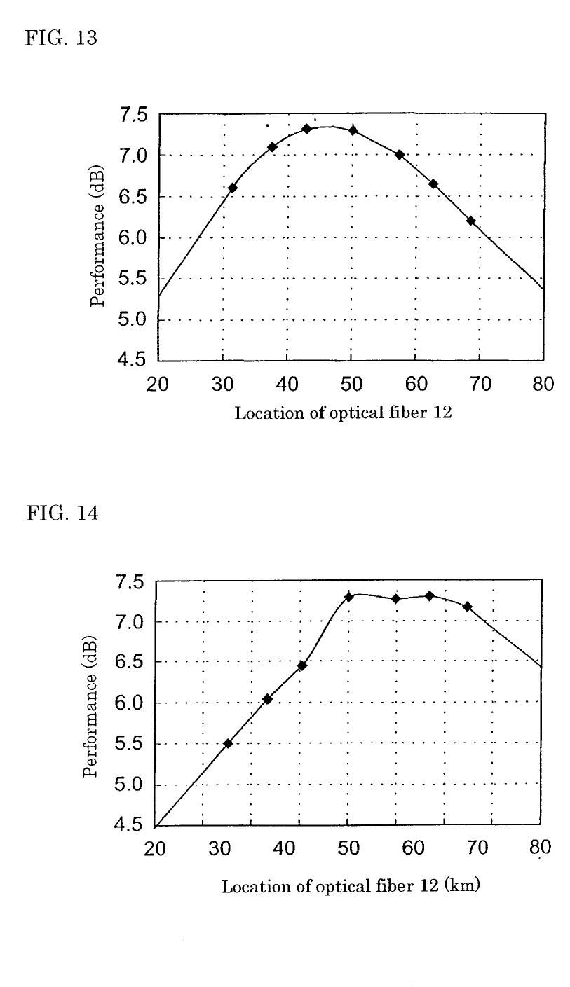

In the example of the second embodiment described above, the length L₁ and the length L₃ were equal to each other, and the optical fiber 12 was disposed in the middle of the optical transmission line 20. The dependence of the PFM of the optical transmission line 20 on the location of the optical fiber 12 is described below for respective cases of forward pumping, backward pumping, and bi-directional pumping. FIGS. 12 to 14 are graphs showing the relationship between the PFM of the optical transmission line 20 and the location of the optical fiber 12, according to the second embodiment. FIG. 12 shows the PFM of the optical transmission line 20 for a case in which Raman amplification pumping light is supplied forwardly to the optical transmission line 20 only from the optical repeater 30. FIG. 13 shows the PFM of the optical transmission line 20 for a case in which Raman amplification pumping light is supplied backwardly to the optical transmission line 20 only from the optical repeater 40. FIG. 14 shows the PFM of the optical transmission line 20 for a case in which Raman amplification pumping light is supplied in both directions to the optical transmission line 20 from the optical repeaters 30 and 40. In these figures, the horizontal axis represents the location of the center of the optical fiber 12. Herein, an optical fiber 12f shown in Table I was employed as the optical fiber 12.

The PFM shown in FIG. 12 tends to be lower than that shown in FIG. 13 and than that shown in FIG. 14. This is because the forward pumping needs greater optical signal power input to the optical fiber 11 compared with the backward pumping and the bi-directional pumping, and thus the forward pumping tends to cause nonlinear optical phenomena to occur. That is, the backward pumping and the bi-directional pumping are superior to the forward pumping.

In the case of the backward pumping (FIG. 13), the optical transmission line 20 has high performance and the variation in the PFM due to the change in the location of the optical fiber 12 is relatively small if the center of the optical fiber 12 is located at a position within the range from the center of the optical transmission line 20 to a point shifted by 10% in a direction toward the front-end side, that is, if the ratio ((L₁+0.5L₂)/(L₁+L₂+L₃)) is not less than 0.4 and not more than 0.5. This means that it is not necessary to precisely control the length of each optical fiber used to form the optical transmission line 20, as long as the location of the optical fiber 12 is within the above-described range. This is advantageous from the point of view of the production control and production cost.

In the case of the bi-directional pumping (FIG. 14), the optical transmission line 20 has high performance and the variation in the PFM is small if the center of the optical fiber 12 is located within the range from the center of the optical transmission line 20 to a point shifted by 20% in a direction toward the rear-end side, that is, if the ratio R is within the range from 0.5 to 0.7. Also in this case, it is not necessary to precisely control the length of each optical fiber used to form the optical transmission line 20, as long as the location of the optical fiber 12 is within the above-described range. This is advantageous from the point of view of the production control and production cost.

What is claimed is:

1. An optical transmission line comprising a first optical fiber and a second optical fiber that are connected together, said first optical fiber having a first effective core area and a first positive chromatic dispersion at a wavelength of 1550 nm, said second optical fiber having a second effective core area and a second negative chromatic dispersion at a wavelength of 1550 nm, wherein
said second optical fiber includes a core including the center of an optical axis, a cladding disposed around said core, and a depressed region disposed between said core and said cladding, said depressed region having a refractive index smaller than the refractive indexes of said core and said cladding;
said second effective core area is smaller than said first effective core area;
said second negative chromatic dispersion is smaller in absolute value than said first positive chromatic dispersion; and
when the length of the first optical fiber and the length of the second optical fiber are represented by L₁ and L₂, respectively, the ratio (L₂/(L₁+L₂)) is not less than 0.5.

2. An optical transmission line according to claim 1, wherein said ratio (L₂/(L₁+L₂)) is not less than 0.55 and not more than 0.60.

3. An optical transmission line according to claim 1, wherein said second optical fiber is disposed on the downstream side relative to said first optical fiber.

4. An optical transmission line according to claim 1, wherein said first effective core area is not less than 100 μm².

5. An optical transmission line according to claim 1, wherein said second effective core area is not less than 20 μm².

6. An optical transmission line according to claim 1, wherein the relative refractive index difference of said core to the cladding of said second optical fiber is not less than 0.9% and not more than 1.0%.

7. An optical transmission line comprising a first optical fiber, a second optical fiber, and a third optical fiber, said first, second, and third optical fibers being connected together in this sequence and disposed between a signal light incidence position and signal light exit position, said first optical fiber having a first effective core area and a first positive chromatic dispersion at a wavelength of 1550 nm, said second optical fiber having a second effective core area and a second negative chromatic dispersion at a wavelength of 1550 nm, said third optical fiber having a third effective core area and a third positive chromatic dispersion at a wavelength of 1550 nm, wherein
said second optical fiber includes a core including the center of an optical axis, a cladding disposed around said core, and a depressed region disposed between said core and said cladding, said depressed region having a refractive index smaller than the refractive indexes of said core and said cladding;
said second effective core area is smaller than said first effective core area and said third effective core area;
said second chromatic dispersion is not less than −73 ps/nm/km and not more than −46 ps/nm/km; and
when the length of the first optical fiber, the length of the second optical fiber, and the length of the third optical fiber are represented by L₁, L₂, and L₃, respectively, the ratio (L₂/(L₁+L₂+L₂)) is not less than 0.2 and not more than 0.4.

8. An optical transmission line according to claim 7, wherein said first effective core area is not less than 100 μm².

9. An optical transmission line according to claim 7, wherein said second effective core area is not less than 15 μm².

10. An optical transmission line according to claim 7, wherein said third effective core area is not less than 100 μm².

11. An optical transmission line according to claim 7, wherein the relative refractive index difference of said core to the cladding of said second optical fiber is not less than 1.4% and not more than 1.8%.

12. An optical transmission line according to claim 7, wherein the ratio ((L₁+0.5L₂)/(L₁+L₂+L₃)) is not less than 0.4 and not more than 0.5, and Raman amplification pumping light used for Raman amplification of signal light is supplied from said light exit position.

13. An optical transmission line according to claim 7, wherein the ratio ((L₁+0.5L₂)/(L₁+L₂+L₃)) is not less than 0.5 and not more than 0.7, and Raman amplification pumping light used for Raman amplification of signal light is supplied from said light incidence position and said light exit position.

14. An optical communication system comprising a first optical fiber, a second optical fiber and a Raman amplification pumping light source, said first optical fiber and said second optical fiber being connected together so as to form an optical transmission line; said first optical fiber having a first effective core area and a first positive chromatic dispersion at a wavelength of 1550 nm, said second optical fiber having a second effective core area and a second negative chromatic dispersion at a wavelength of 1550 nm, wherein
said second optical fiber includes a core including the center of an optical axis, a cladding disposed around said core, and a depressed region disposed between said core and said cladding, said depressed region having a refractive index smaller than the refractive indexes of said core and said cladding;
said second effective core area is smaller than said first effective core area;
said second negative chromatic dispersion is smaller in absolute value than said first positive chromatic dispersion;
when the length of the first optical fiber and the length of the second optical fiber are represented by L₁ and L₂, respectively, the ratio (L₂/(L₁+L₂)) is not less than 0.5; and
signal light is amplified by means of Raman amplification while the signal light propagates through said optical transmission line.

15. An optical communication system comprising a first optical fiber, a second optical fiber, a third optical fiber, and a Raman amplification pumping light source, said first, second, and third optical fibers being connected in this sequence so as to form an optical transmission line and disposed between a signal light incidence position and signal light exit position; said first optical fiber having a first effective core area and a first positive chromatic dispersion at a wavelength of 1550 nm, said second optical fiber having a second effective core area and a second negative chromatic dispersion at a wavelength of 1550 nm, said third optical fiber having a third effective core area and a third positive chromatic dispersion at a wavelength of 1550 nm, wherein
said second optical fiber includes a core including the center of an optical axis, a cladding disposed around said core, and a depressed region disposed between said core and said cladding, said depressed region having a refractive index smaller than refractive indexes of said core and said cladding;
said second effective core area is smaller than said first effective core area and said third effective core area;
said second chromatic dispersion is not less than −73 ps/nm/km and not more than −46 ps/nm/km;
when the length of the first optical fiber, the length of the second optical fiber, and the length of the third optical fiber are represented by L₁, L₂, and L₃, respectively, the ratio (L₂/(L₁+L₂+L₂)) is in the range from 0.2 to 0.4; and
signal light is amplified by means of Raman amplification while the signal light propagates through said optical transmission line.
